(19) United States
(12) Patent Application Publication
(10) Pub. No.: US 2015/0206683 A1
(43) Pub. Date: Jul. 23, 2015

(54) SWITCHGEAR

(71) Applicant: Kabushiki Kaisha Toshiba, Tokyo (JP)

(72) Inventors: Yoshiaki Ohda, Yokohama (JP); Tadashi Koshizuka, Saitama (JP); Masayuki Sato, Yokohama (JP); Kasuhisa Kanaya, Yokohama (JP); Yuki Matsui, Tokyo (JP)

(21) Appl. No.: 14/675,134

(22) Filed: Mar. 31, 2015

Related U.S. Application Data
(63) Continuation of application No. PCT/JP2014/068268, filed on Jul. 9, 2014.

(30) Foreign Application Priority Data
Sep. 10, 2013 (JP) 2013-187787

(51) Int. Cl. H01H 50/60; H01H 33/66; H01H 47/22; H01H 50/64

(52) U.S. Cl. CPC H01H 50/60; H01H 50/641; H01H 33/66; H01H 47/22; H01H 2205/002

(57) ABSTRACT

Provided is a switchgear which is capable of easily accomplishing an interruption task required in a high-voltage-purpose switchgear and which is short in the interruption time. The switchgear includes a pressure container 1 and 2 filled with an insulating medium, a plurality of contact point units 7 and 9, an insulation spacer 3 configured to divide the inside of the pressure containers 1 and 2 into the same number of internal spaces 101 and 102 as the number of the contact point units, and a spacer electrode 6 extending through the insulation spacer 3 and fixed to the insulation spacer 3. The contact point units 7 and 9 include contact points and an operating unit 29 for operating the contact points. The contact point units 7 and 9 are installed in the internal spaces 101 and 102, one in each space.

### CROSS-REFERENCE TO RELATED APPLICATIONS

This application is a Continuation of PCT Application No. PCT/JP2014/068268, filed on Jul. 9, 2014, and claims priority to Japanese Patent Application No. 2013-187787, filed on Sep. 10, 2013, the entire contents of both of which are incorporated herein by reference.

### TECHNICAL FIELD

Embodiments of the present disclosure relate to a multi-point cut switchgear for bringing a plurality of contact points into contact or out of contact with each other.

### BACKGROUND

A high-voltage-purpose switchgear having a fault current interruption task is required to be capable of reliably interrupting a small current and a large current. Particularly, with regard to the large current, the switchgear needs to satisfy the following two interruption tasks.

One of the interruption task is the interruption of a current in case of short line fault (SLF) in which a voltage of triangular waveform having a low absolute value but a steep change rate appears at the initial stage of the rise of a voltage available immediately after current zero (a transient recovery voltage). The other interruption task is the interruption of a current in case of breaker terminal fault (BTF) in which the initial rise of a transient recovery voltage is gentle but a voltage having a large absolute value is applied at the final stage.

In recent years, there has been extensively used a puffer-type switchgear of the type in which one interruption unit having a contactable/separable contact point is accommodated within a pressure container filled with an SF₆ gas as an insulating gas and in which the insulating gas is blown toward the contact point during an interruption operation to thereby extinguish an arc. In this case, it is necessary for one switchgear to accomplish the two interruption tasks mentioned above.

In the meantime, there has been developed a switchgear of the type in which interruption units specialized in the respective interruption tasks are connected so as to accomplish the two interruption tasks mentioned above. That is to say, the switchgear is of the type including a plurality of interruption units which shares the respective interruption tasks with one another. In this switchgear, the internal space of a pressure container is divided into two spaces. A puffer-type interruption unit superior in the BTF interruption performance is accommodated in one space. A puffer-type interruption unit superior in the SLF interruption performance is accommodated in the other space. The puffer-type interruption units are electrically connected to each other in series.

In the switchgear configured by interconnecting the interruption units specialized in the respective interruption tasks, the respective interruption units have contactable/separable contact points. An interruption operation and a feed operation of all the contact points are performed by a single operating unit (actuator). Thus, the burden borne by the operating unit becomes larger.

The causes of the burden borne by the operating unit becoming larger includes not only the increase in the number of the contact points that performs the interruption/feed operations but also the loss attributable to the structure for transmitting a driving force of the single operating unit to the contact points. The operating unit is installed outside the pressure container within which the contact points are disposed. For that reason, in order to transmit the driving force of the operating unit to the contact points disposed within the pressure container, it is necessary to increase the number of transmission units which are formed of a rotary lever and a link mechanism. As a result, the weight of the configuration for transmitting the driving force of the operating unit to the contact points increases.

Consequently, a large driving force is required and the kind and size of the operating unit are limited. If the operating energy cannot be increased, there is posed a problem in that the interruption time becomes longer.

### SUMMARY

A switchgear according to the present embodiment seeks to solve the aforementioned problems. It is an object of the present disclosure to provide a switchgear which is capable of easily accomplishing the interruption tasks required in a high-voltage-purpose switchgear and which is short in the interruption time.

In order to achieve the above object, a switchgear of the present embodiment includes: a sealed container filled with an insulating medium; a plurality of contact point units each having a contact point; an insulation spacer configured to divide the inside of the sealed container into the same number of internal spaces as the number of the contact point units; and an electrode extending through the insulation spacer and fixed to the insulation spacer. The contact point units are installed in the respective internal spaces, each of the contact point units including a contact point formed of a fixed electrode and a movable electrode capable of making contact with or moving away from the fixed electrode. The switchgear further includes a connecting member disposed within the sealed container, the connecting member configured to link a contact/separation operation of the movable electrode relative to the fixed electrode of one of the internal spaces to a contact/separation operation of the movable electrode of another internal space. The respective movable electrodes are driven in conjunction with each other by an operating unit for driving one of the movable electrodes.

### BRIEF DESCRIPTION OF THE DRAWINGS

FIG. 1 is a sectional view showing the overall configuration of a switchgear according to a first embodiment, in which view a feed state is shown.

FIG. 2 is a sectional view showing the overall configuration of the switchgear according to the first embodiment, in which view an interruption state is shown.

FIG. 3 is a sectional view showing the overall configuration of a switchgear according to a second embodiment, in which view a feed state is shown.

FIG. 4 is a sectional view showing the overall configuration of the switchgear according to the second embodiment, in which view an interruption state is shown.

### DETAILED DESCRIPTION

### First Embodiment

### Overall Configuration

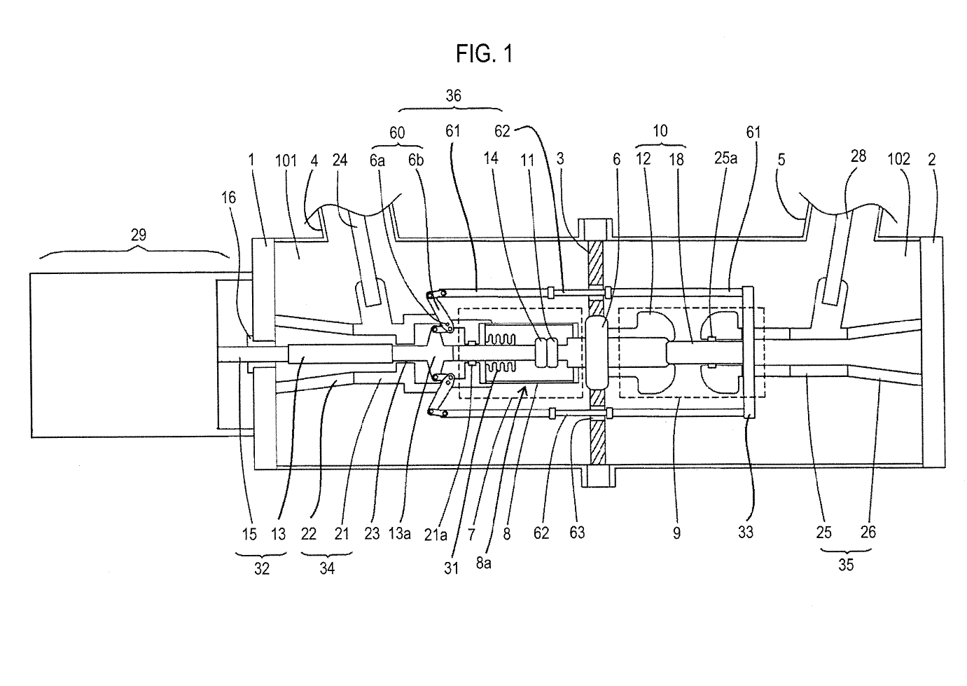

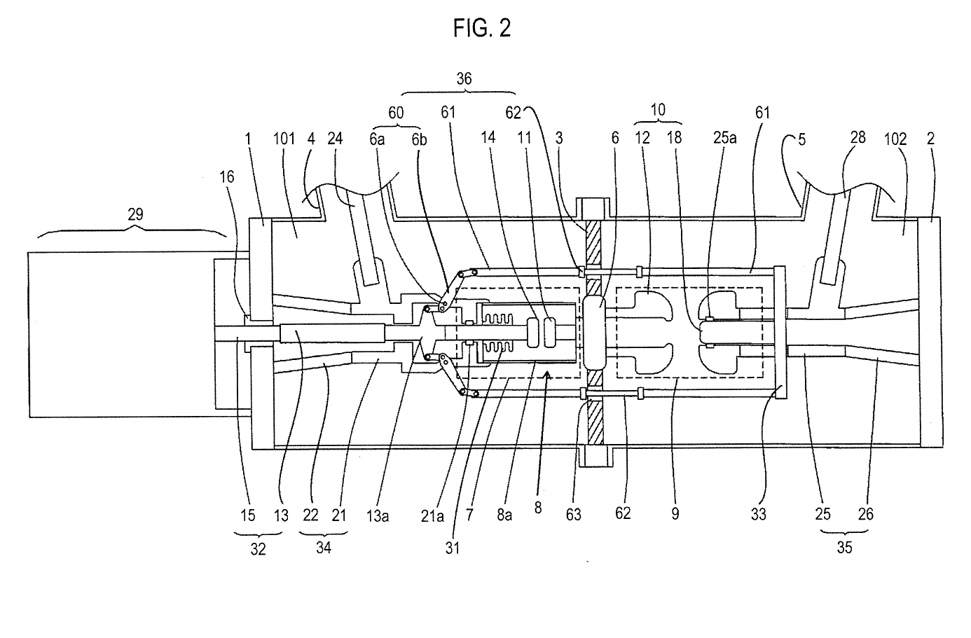

The configuration of a switchgear of the present embodiment will now be described with reference to FIGS. 1 and 2. FIGS. 1 and 2 are sectional views showing the overall configuration of the switchgear of the present embodiment.

The switchgear of the present embodiment includes a plurality of contact point units in which a plurality of contact points is electrically connected in series. A feed state and an interruption state of a current are switched by bringing the contact points into contact or out of contact with each other. In this case, a driving force of one operating unit is transmitted to a plurality of contact point units. The switchgear of the present embodiment includes pressure containers 1 and 2 made of a grounded metal or an insulator, bushings 4 and 5 connected to the pressure containers 1 and 2, a plurality of (two, in the present embodiment) contact point units 7 and 9 each having a pair of contactable/separable contact points, an insulation spacer 3 for dividing the inside of the pressure containers 1 and 2 into the same number of spaces as the number of the contact point units (two spaces in the present embodiment), and a spacer electrode 6 extending through the insulation spacer 3 and fixed to the insulation spacer 3.

Each of the pressure containers 1 and 2 is a cylindrical container having a bottom at one side and an opening at the opposite side. The open end of the cylindrical container is formed of a flange portion. A sealed vessel is configured by the pressure containers 1 and 2. The pressure containers 1 and 2 are fastened to each other in the mutually-facing flange portions with the insulation spacer 3 interposed therebetween.

The contact points of the contact point unit 7 are accommodated within the pressure container 1. The contact points of the contact point unit 9 are accommodated within the pressure container 2. The contact points are electrically serially connected to the spacer electrode 6 fixed to the insulation spacer 3. Conductors 24 and 28 are disposed within the bushings 4 and 5 so as to extend toward the contact point units 7 and 9. The conductor 24 is electrically connected to the contact point unit 7. The conductor 28 is electrically connected to the contact point unit 9.

When the switchgear is in a feed state, a current flows in from the bushing 4 and flows out toward the bushing 5 via the conductor 24, the contact points of the contact point unit 7, the spacer electrode 6, the contact points of the contact point unit 9 and the conductor 28 sequentially. When the switchgear is in an interruption state, the contact points of the contact point units 7 and 9 are separated, whereby the current is interrupted. Hereinafter, the detailed configuration of the switchgear of the present embodiment will be described.

### (Detailed Configuration)

### (Internal Spaces 101 and 102)

An internal space 101 is formed by the pressure container 1, the insulation spacer 3 and the bushing 4. An internal space 102 is formed by the pressure container 2, the insulation spacer 3 and the bushing 5. The internal spaces 101 and 102 are kept in a sealed state. In the present embodiment, the internal spaces 101 and 102 are kept in a completely sealed state. The internal spaces 101 and 102 are filled with an insulating medium.

The insulating medium may be, e.g., a sulfur hexafluoride gas (SF₆ gas), carbon dioxide, nitrogen, a dry air, a mixed gas thereof, or insulating oil. In the present embodiment, the internal spaces 101 and 102 are filled with an SF₆ gas. The pressure of the internal space 101 and the pressure of the internal space 102 can be kept at different pressures or at an equal pressure by a gas supply system or a vacuum pump (not shown) depending on the necessity. In the present embodiment, the gas pressure of the internal space 101 is equal to or lower than the gas pressure of the internal space 102 and is equal to or higher than the atmospheric pressure.

### (Contact Point Unit 7)

The contact point unit 7 is a vacuum contact point unit in which an electrode is accommodated within a vacuum container of high vacuum. The contact point unit 7 performs the interruption of a current using the superior dielectric strength and the superior arc-extinguishing property of the high vacuum. Hereinafter, the contact point unit 7 will be referred to as a vacuum contact point unit 7. The vacuum contact point unit 7 includes a vacuum valve 8 having a contact point. An operating unit 29 for driving the contact point of the vacuum valve 8 of the vacuum contact point unit 7 is installed. Moreover, there are installed a connecting unit 32 for transmitting a driving force of the operating unit 29 to the contact point of the vacuum valve 8 and a transmitting unit 36 for transmitting the driving force of the operating unit 29 to another contact point in conjunction with the connecting unit 32. There is also provided a support unit 34 connected to the other end of the vacuum valve 8 whose one end is connected to the spacer electrode 6. The support unit 34 supports the sliding movement of the connecting unit 32 and supports the contact point of the vacuum valve 8 within the pressure container 1.

The vacuum valve 8 includes a cylindrical vacuum container 8a, the inside of which is kept in a high vacuum state. The vacuum container 8a is accommodated within the pressure container 1. The vacuum container 8a is an insulation cylinder made of, e.g., glass or ceramic. A pair of fixed electrode 11 and movable electrode 14, which constitute a contact point, and a bellows 31 are accommodated within the vacuum container 8a.

Within the vacuum valve 8, the fixed electrode 11 and the movable electrode 14 are disposed to face each other. The fixed electrode 11 is fixed to the spacer electrode 6 which is fixed to the insulation spacer 3. The fixed electrode 11 and the movable electrode 14 can be mechanically contacted or separated. If the switchgear is converted from the feed state to the interruption state, the movable electrode 14 is separated from the fixed electrode 11. An arc is generated between the fixed electrode 11 and the movable electrode 14. One end of the movable electrode 14 faces the fixed electrode 11 and the other end of the movable electrode 14 passes through the wall surface of the vacuum container 8a and extends to the outside of the vacuum valve 8. The bellows 31 is installed on the inner wall surface of the vacuum container 8a at a position where the movable electrode 14 passes through the wall surface of the vacuum container 8a. The bellows 31 is extendable and retractable. The bellows 31 keeps the inside of the vacuum container 8a air-tight even when the movable electrode 14 is separated from the fixed electrode 11.

The operating unit 29 is disposed outside the pressure container 1. The operating unit 29 moves the movable electrode 14, thereby bringing the movable electrode 14 into contact or out of contact with the fixed electrode 11. That is to say, the movable electrode 14 is pushed and pulled along a straight line by the driving force of the operating unit 29, whereby the movable electrode 14 can be brought into contact with or separated from the fixed electrode 11. The driving of the operating unit 29 can be started in response to, e.g., a command signal transmitted from a control device installed outside the switchgear. The connecting unit 32 and the transmitting unit 36 are installed between the operating unit 29 and the movable electrode 14.

The connecting unit 32 includes a rod-shaped insulation rod 13 made of an insulating material and a rod-shaped operating rod 15 made of an electrically conductive material. The insulation rod 13 and the operating rod 15 are disposed on the same axis as the fixed electrode 11 and the movable electrode 14. One end of the insulation rod 13 is connected to the transmitting unit 36 and the other end of the insulation rod 13 is connected to the operating rod 15. The operating rod 15 extends from the insulation rod 13 through the wall surface of the pressure container 1 and protrudes toward the outside of the pressure container 1. The operating rod 15 is connected to the operating unit 29.

A seal portion 16 including an elastic packing not shown is installed in the wall surface portion of the pressure container 1 through which the operating rod 15 passes. The air-tightness of the internal space 101 is maintained even when the operating rod 15 makes sliding contact with the packing of the seal portion 16.

The transmitting unit 36 is connected to the connecting unit 32 and is moved in conjunction with the connecting unit 32. The driving force of the operating unit 29 is transmitted a plurality of movable electrodes disposed within the internal spaces. In the present embodiment, the driving force of the operating unit 29 is transmitted to the movable electrode 14 and the movable electrode 18.

The transmitting unit 36 includes a connecting rod 13a connected to the insulation rod 13, a link mechanism 60 connected to the connecting rod 13a for converting the motion of the connecting unit 32 to the opposite direction, and an insulation operating rod 61 extending through the insulation spacer 3 connected to the link mechanism 60.

The connecting rod 13a is a member having a cross-shaped cross section. One side of the connecting rod 13a having a substantially cross shape extends in the direction coaxial with the insulation rod 13 and the movable electrode 14 (in the left-right direction in the figure). One end of one side of the connecting rod 13a is connected to the insulation rod 13. The other end of one side of the connecting rod 13a is connected to the movable electrode 14. Another side of the connecting rod 13a having a substantially cross shape extends in the direction orthogonal to the axial direction of the insulation rod 13 and the movable electrode 14 (in the up-down direction in the figure). The opposite ends of another side of the connecting rod 13a are connected to the link mechanism 60.

The link mechanism 60 between the connecting rod 13a and the insulation operating rod 61 is a member which transmits the driving force applied to the connecting rod 13a and which reverses the direction of the driving force applied to the connecting rod 13a. The link mechanism 60 includes a link member 6b which transmits the driving force, and a fulcrum 6a which supports the link member 6b. The link member 6b is configured by interconnecting a plurality of rod-shaped members. One end of the link member 6b is connected to the connecting rod 13a. The other end of the link member 6b is connected to the insulation operating rod 61. The fulcrum 6a is disposed in a conduction support portion 21. The fulcrum 6a serves as a pivot point during the motion of the link member 6b. The link member 6b is configured to rotate about the fulcrum 6a.

The insulation operating rod 61 is a member which transmits the driving force transmitted from the link mechanism 60 to another internal space. The insulation operating rod 61 is a rod-shaped member. One end of the insulation operating rod 61 is connected to the link mechanism 60.

A seal rod 62 is disposed in the portion where the insulation operating rod 61 passes through the insulation spacer 3. The seal rod 62 is slidable with respect to the insulation spacer 3. The seal rod 62 is slidably supported by a seal support body 63 embedded in the insulation spacer 3. The seal support body 63 keeps the internal spaces 101 and 102 air-tight using an elastic packing not shown. The seal rod 62 is connected to the insulation operating rod 61 which transmits the driving force to the movable electrode disposed within the internal space 102.

One end of the support unit 34 is fixed to the wall surface of the pressure container 1 in which the seal portion 16 is installed. The other end of the support unit 34 is connected to the movable electrode 14. The support unit 34 includes an insulation support portion 22 surrounding the insulation rod 13 and extending toward the insulation spacer 3 from the wall surface of the pressure container 1 in which the seal portion 16 is installed, and a conduction support portion 21 connected at one end to the insulation support portion 22 and connected at the other end to the movable electrode 14,

The insulation support portion 22 and the conduction support portion 21 are concentrically installed so as not to make contact with the insulation rod 13 and the operating rod 15. A conduction contactor 23 made of an electrically conductive material is disposed between the conduction support portion 21 and the movable electrode 14 and is electrically connected to the conduction support portion 21 and the movable electrode 14. The movable electrode 14 can be slidably moved by the operating unit 29. In the vacuum valve 8, one end of the vacuum container 8a is fixed to the fixed electrode 11 and the other end of the vacuum container 8a is fixed to the support unit 34.

### (Contact Point Unit 9)

As the contact point unit 9, it is possible to use a puffer-type gas contact point unit or a non-puffer-type gas contact point unit. The puffer-type gas contact point unit includes an electrode which constitutes a contact point, a puffer cylinder which accumulates a pressure for blowing an insulating gas toward an arc, and a nozzle which guides the insulating gas blown toward an arc. During the interruption operation and the feed operation, the operating unit also drives these members in conjunction with the electrode. On the other hand, the non-puffer-type gas contact point unit does not include the puffer cylinder and the nozzle. The contact point unit 9 of the present embodiment is of the non-puffer type and is a gas contact point unit which is higher in dielectric strength than the vacuum contact point unit 7 and which can be driven at a high speed. In the following description, the contact point unit 9 will be referred to as a gas contact point unit 9.

The gas contact point unit 9 includes a contact point 10, a transmitting unit 36 which transmits the driving force transmitted from another internal space, an electrode base 33 which transmits the driving force of the transmitting unit 36 to the contact point 10, and a support stand 35 which defines the movement direction of the electrode base 33.

The contact point 10 of the gas contact point unit 9 is higher in dielectric strength than the contact point of the vacuum valve 8 of the vacuum contact point unit 7. The contact point 10 includes a pair of fixed electrode 12 and movable electrode 18 which are disposed within the pressure container 2 so as to face each other. The fixed electrode 12 is fixed to the spacer electrode 6. The movable electrode 18 can be mechanically brought into contact or out of contact with the fixed electrode 12.

The movable electrode 18 is made mechanically contactable and separable by virtue of the electrode base 33 and the transmitting unit 36. The insulation operating rod 61 of the transmitting unit 36 is connected to the electrode base 33. The insulation operating rod 61 and the electrode base 33 are moved together by the driving force of the operating unit 29.

The electrode base 33 has a flat plate shape. The movable electrode 18 is fixed to the central portion of the electrode base 33. The electrode base 33 is slidably supported on the support stand 35. The opposite ends of the electrode base 33 are connected to the insulation operating rod 61. A hole (not shown) slightly larger than the outer diameter of the support stand 35 is formed in a portion of the central region of the electrode base 33. The support stand 35 is fitted into the hole of the electrode base 33. The electrode base 33 is slidable with respect to the support stand 35.

The support stand 35 is fixed at one end to the wall surface of the pressure container 2 and is connected at the other end to the movable electrode 18. The support stand 35 includes an insulation support portion 26 extending from the wall surface of the pressure container 2 toward the insulation spacer 3, and a conduction support portion 25 connected at one end to the insulation support portion 26 and at the other end to the movable electrode 18.

The insulation support portion 26 and the conduction support portion 25 are concentrically installed. A conduction contactor 25a made of an electrically conductive material is disposed between the conduction support portion 25 and the movable electrode 18 and is electrically connected to the conduction support portion 25 and the movable electrode 18. The movable electrode 18 can be slidably moved by the electrode base 33.

### (Feed State)

According to the configuration described above, when the switchgear of the present embodiment is in a feed state, the current introduced from the bushing 4 flows out toward the bushing 5 via the conductor 24, the conduction support portion 21, the conduction contactor 23, the movable electrode 14, the fixed electrode 11, the spacer electrode 6, the fixed electrode 12, the movable electrode 18, the conduction contactor 25a, the conduction support portion 25 and the conductor 28 sequentially.

### (Interruption Operation)

On the other hand, if a current interruption command signal is applied from the outside of the switchgear to the operating unit 29, the movable electrodes 14 and 18 are separated from the fixed electrodes 11 and 12 by the driving force of the operating unit 29, thereby starting current interruption. That is to say, in the switchgear, the movable electrodes 14 and 18 are moved away from the fixed electrodes 11 and 12 by the driving force of the operating unit 29. Thus, current interruption is performed in the vacuum contact point unit 7 and the gas contact point unit 9.

(1) As for the Movement of the Movable Electrode 14

Based on the current interruption command signal, the operating unit 29 applies a driving force, by which the movable electrode 14 is moved away from the fixed electrode 11 (leftward in the figure), to the operating rod 15.

The operating rod 15 is moved away from the fixed electrode 11 (leftward in the figure) by the driving force of the operating unit 29. Since the movable electrode 14 is moved in conjunction with the operating rod 15, the movable electrode 14 of the vacuum valve 8 is separated from the fixed electrode 11. In this process, an arc composed of electrons and particles evaporated from the electrode is generated between the fixed electrode 11 and the movable electrode 14. Inasmuch as the inside of the vacuum container 8a is in a high vacuum state, the constituent substances of the arc are diffused. Thus, the arc cannot retain the shape thereof and is extinguished. As a result, the current is interrupted.

While the vacuum valve 8 is provided with the bellows 31 which is not superior in high-voltage resistance, the pressure of the gas existing within the internal space 101 is set at a pressure that can be endured by the bellows 31, namely a pressure equal to or lower than the gas pressure of the internal space 102 and equal to or higher than the atmospheric pressure. This makes it possible to protect the bellows 31 of the internal space 101 while securing the dielectric strength of the contact point of the internal space 102.

(2) As for the Movement of the Movable Electrode 18

Based on the current interruption command signal, the operating unit 29 applies a driving force, by which the movable electrode 18 is moved away from the fixed electrode 12 (rightward in the figure), through the transmitting unit 36 which moves in conjunction with the operating rod 15.

Initially, the operating unit 29 applies a driving force, by which the movable electrode 14 is moved away from the fixed electrode 11 (leftward in the figure), to the operating rod. The transmitting unit 36 transmits a driving force, which acts in the direction opposite to the direction in which the movable electrode 14 is moved away from the fixed electrode 11 (rightward in the figure), to the insulation operating rod 61 using the link mechanism 60 which reverses the direction of the driving force.

The insulation operating rod 61 is connected to the electrode base 33 within the internal space 102. The insulation operating rod 61 moves the electrode base 33 away from the fixed electrode 12 (rightward in the figure) using the driving force of the operating unit 29. Since the movable electrode 18 is moved in conjunction with the electrode base 33, the movable electrode 18 is moved away from the fixed electrode 12 (rightward in the figure).

In the interruption process, a separation gas of an SF₆ gas generated by an arc is generated within the internal space 102. The separation gas may act to corrode the surface layer of the insulator-made vacuum container 8a of the vacuum valve 8. Since the vacuum container 8a is accommodated within the sealed internal space 101, there is no fear that the vacuum container 8a is corroded by the separation gas generated within the internal space 102.

In the aforementioned interruption process, the steep transient recovery voltage in the SLF interruption task is borne by the vacuum contact point unit 7. The high transient recovery voltage in the BTF interruption task is borne by the gas contact point unit 9 which is high in the dielectric strength. It is therefore possible to easily accomplish the two interruption tasks.

### (Effects)

(1) The switchgear of the present embodiment includes different kinds of contact point units. Therefore, as compared with a switchgear including a single contact point unit, it is possible to perform the current interruption and the securing of the insulation distance within a short period of time.

(2) In the present embodiment, the transmitting unit 36 for transmitting the driving force of the operating unit 29 to the movable electrode 18 is disposed within the pressure container 1. Therefore, as compared with a case where the transmitting unit 36 is disposed outside the pressure container 1, it is possible to simplify the configuration of the transmitting unit 36. For that reason, it is possible to reduce the loss of the driving force which may be caused by the configuration of the transmitting unit 36 becoming complex. Thus, as compared with a case where the transmitting unit 36 for transmitting the driving force of the operating unit 29 to the movable electrode 18 is disposed outside the pressure container 1, it is possible to reduce the weight of the transmitting unit. For that reason, even if the driving force of the operating unit 29 is small, it is possible to perform the current interruption and the securing of the insulation distance within a short period of time.

(3) The contact point unit 7 further includes the connecting unit 32 which transmits the driving force of the operating unit 29 to the contact point. The operating unit 29 is disposed outside the pressure containers 1 and 2. The connecting unit 32 is connected to the operating unit 29 through the pressure container 1 while maintaining the air-tightness of the inside of the pressure container 1. Thus, there is no possibility that the operating unit 29 makes direct contact with the separation gas of the SF₆ gas generated by the arc in the interruption process. It is therefore possible to prevent the separation gas from corroding the operating unit 29.

(4) Among a plurality of contact point units, at least one contact point unit may be the vacuum contact point unit 7 including the vacuum valve provided with the contact point and at least one contact point unit may be the gas contact point unit 9 including the contact point 10 which is larger in the dielectric strength than the contact point of the vacuum valve 8. Thus, in the interruption process, the steep transient recovery voltage in the SLF interruption task is borne by the vacuum contact point unit 7 and the high transient recovery voltage in the BTF interruption task is borne by the gas contact point unit 9 which is high in the dielectric strength. This makes it possible to easily accomplish the two interruption tasks. By providing at least one vacuum contact point unit 7 and at least one gas contact point unit 9 in this way, it is possible for the respective contact point units to divisionally bear and accomplish the SLF interruption task and the BTF interruption task.

(5) The vacuum valve 8 of the vacuum contact point unit 7 is a contact-type contact point. The weight of the movable electrode 14 can be made small. This makes it possible to perform the interruption operation within an extremely short period of time. The gas contact point unit 9 of the present embodiment does not include a puffer cylinder and a nozzle in the movable electrode 18. Therefore, as compared with a puffer-type contact point unit, the movable weight driven by the operating unit 29 is reduced. For that reason, the operating unit 29 can drive the movable electrodes 14 and 18 at an increased speed. It is therefore possible to significantly shorten the time required in securing the insulation distance. As described above, as compared the conventional switchgear including a plurality of puffer-type contact point units, the switchgear of the present embodiment can perform the current interruption and the securing of the insulation distance within a short period of time. It is therefore possible to shorten the interruption time.

(6) The switchgear of the present embodiment has a structure in which the internal space 101 and the internal space 102 are sealed. This makes it possible to independently set the pressure of the internal space 101 and the internal space 102 at different pressures. Specifically, the gas pressure of the internal space 101 is set equal to or lower than the gas pressure of the internal space 102 and equal to or higher than the atmospheric pressure. Thus, it is possible to protect the bellows 31 of the internal space 101 while securing the dielectric strength of the contact point of the internal space 102.

### Second Embodiment

### Configuration

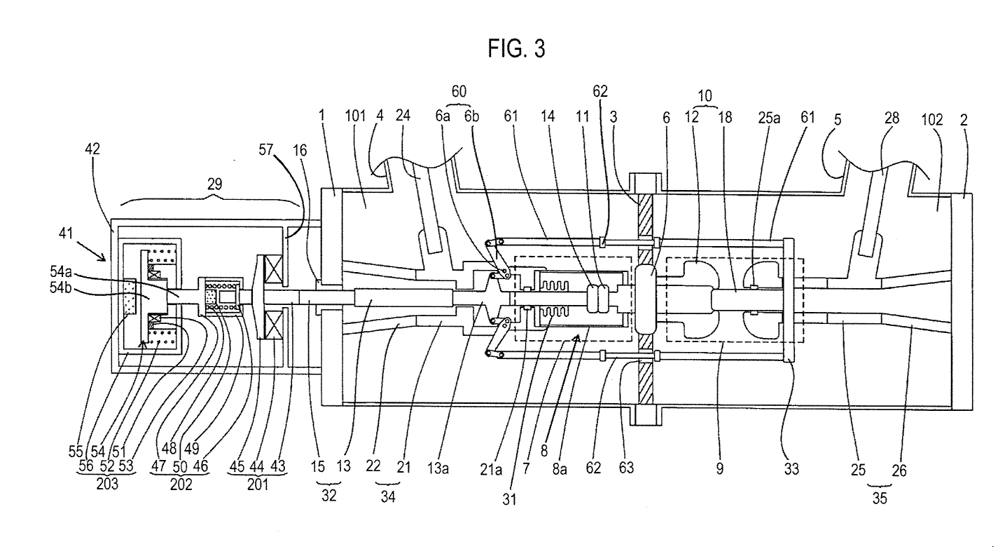

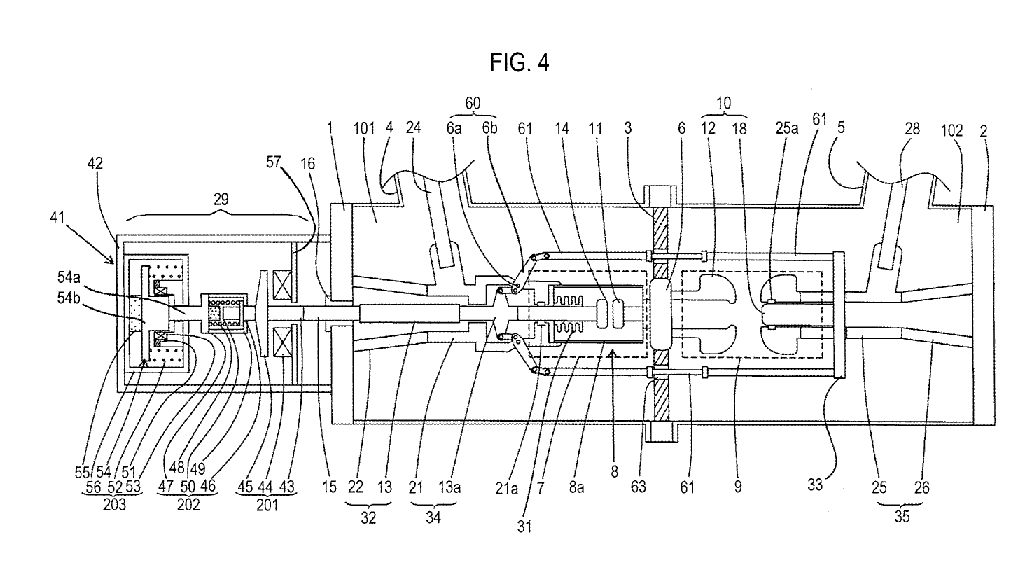

A second embodiment will now be described with reference to FIGS. 3 and 4. FIGS. 3 and 4 are sectional views of a vacuum contact point unit 7 according to the second embodiment. FIG. 3 shows a feed state of the contact point units 7 and 9. FIG. 4 shows an interruption state of the contact point units 7 and 9. The second embodiment is identical in basic configuration with the first embodiment. Only the points differing from the first embodiment will be described. Parts identical with those of the first embodiment will be designated by like reference symbols with the detailed description thereon omitted.

The switchgear of the second embodiment uses an electromagnetic rebound operating unit 41 as the operating unit of the vacuum contact point unit 7. The electromagnetic rebound operating unit 41 makes use of an electromagnetic rebound force and has a high responsiveness in an opening operation. The electromagnetic rebound operating unit 41 includes a mechanism box 42, a high-speed opening unit 201, a wiping mechanism unit 202 and a holding mechanism unit 203.

The mechanism box 42 is a hollow box which is opened on one end surface and which has an opening edge fixed and connected to the wall surface of the pressure container 1 on which the seal portion 16 is installed. The high-speed opening unit 201, the wiping mechanism unit 202 and the holding mechanism unit 203 are accommodated within the mechanism box 42.

The high-speed opening unit 201 includes a movable shaft 43, an electromagnetic rebound coil 44 and a rebound ring 45. The movable shaft 43 is a rod-shaped body connected to the operating rod 15. The rebound ring 45 is a ring-shaped body made of a good conductor and is fixed to the periphery of the movable shaft 43 with the movable shaft 43 fitted to a ring-shaped hole of the rebound ring 45. A support portion 57 is fixed to the inner wall of the mechanism box 42. The support portion 57 extends toward the movable shaft 43. The electromagnetic rebound coil 44 is made of a good conductor. The electromagnetic rebound coil 44 is installed on the support portion 57 so as to face the rebound ring 45. A coil excitation means not shown is connected to the electromagnetic rebound coil 44. A current can be supplied from a capacitor of the coil excitation means to the electromagnetic rebound coil 44. The electromagnetic rebound coil 44 is excited by the current. The electromagnetic rebound coil 44 applies an electromagnetic rebound force to the rebound ring 45, thereby driving the movable shaft 43. Examples of the good conductor used in the electromagnetic rebound coil 44 and the rebound ring 45 include copper, silver, gold, aluminum and iron.

The wiping mechanism unit 202 transmits the electromagnetic rebound force of the high-speed opening unit 201 to the holding mechanism unit 203. The wiping mechanism unit 202 includes a brim 46 fitted to the movable shaft 43, a coupling 47 made of an insulating material, a wiping spring 48 disposed between the brim 46 and the coupling 47, a brim presser 49 for pressing the brim 46, and a shock absorber 50 for suppressing a shock when the movable shaft 43 collides.

The coupling 47 is, e.g., a flat plate, and is disposed so as to face the brim 46. The wiping spring 48 is connected at one end to the brim 46 and at the other end to the coupling 47 in a state in which a biasing force is applied to the brim 46 and the coupling 47. The brim presser 49 is a closed-bottom tubular body having a bottom surface. The brim presser 49 is fixed to the coupling 47 so as to surround the brim 46 and the wiping spring 48. The bottom surface of the brim presser 49 serves as a stopper of the brim 46. An opening is formed on the bottom surface of the brim presser 49. The movable shaft 43 can move through the opening. The shock absorber 50 is fixed to the coupling 47. The shock absorber 50 absorbs a shock generated by the collision of the movable shaft 43.

The holding mechanism unit 203 includes a permanent magnet 51, a circuit-opening spring 52, an electromagnetic solenoid 53, a movable member 54, a shock absorber 55 and a holding mechanism box 56. The holding mechanism box 56 is fixed to the inner surface of the mechanism box 42. The permanent magnet 51, the circuit-opening spring 52, the electromagnetic solenoid 53, the movable member 54 and the shock absorber 55 are accommodated within the holding mechanism box 56.

The movable member 54 is made of a magnetic material on which the attracting force of the permanent magnet 51 works. The movable member 54 has a substantially T-like shape and includes a leg 54a extending from the opening of the holding mechanism box 56 toward the movable shaft 43. The leg 54a is fixed to the coupling 47. The permanent magnet 51 is fixed to the inner surface of the holding mechanism box 56 facing the movable shaft 43. The permanent magnet 51 faces two hands 54b of the movable member 54. The permanent magnet 51 attracts the movable member 54. That is to say, the permanent magnet 51, the electromagnetic solenoid 53 and the movable member 54 generates a thrust force acting in the direction in which the movable electrode 14 constituting the contact point of the vacuum valve 8 is closed.

The circuit-opening spring 52 is installed between the two hands 54b of the movable member 54 and the wall surface of the holding mechanism box 56 on which the permanent magnet 51 is installed, so as to apply a biasing force to the movable member 54. The circuit-opening spring 52 used is of the type in which, in an open-circuit state, the biasing force is larger than the sum of the self-closing force of the vacuum valve 8 and the attracting force of the permanent magnet 51 and in which, in a closed-circuit state, the biasing force is smaller than the attracting force of the permanent magnet 51 exerted on the movable member 54.

The electromagnetic solenoid 53 is a coil made of an electrically conductive material. The electromagnetic solenoid 53 is wound around and fixed to the root of the leg 54a of the movable member 54. An external power supply not shown is connected to the electromagnetic solenoid 53. The electromagnetic solenoid 53 can be excited by supplying a current from the external power supply to the electromagnetic solenoid 53. The shock absorber 55 is fixed to the inner surface of the holding mechanism box 56 which faces the opening of the holding mechanism box 56.

### (Interruption Operation)

Description will now be made on the opening operation of the electromagnetic rebound operating unit 41 in the interruption operation process of the switchgear of the present embodiment. First, if an opening command is issued from the outside of the switchgear to the coil excitation means in a closed-circuit state in which the fixed electrode 11 and the movable electrode 14 of the vacuum valve 8 make contact with each other, a current is supplied from the capacitor of the coil excitation means to the electromagnetic rebound coil 44, whereby the electromagnetic rebound coil 44 is excited. Thus, an electromagnetic rebound force is applied to the rebound ring 45. Through the movable shaft 43 and the connecting unit 32, the movable electrode 14 performs an opening operation at a high speed from the fixed electrode 11 toward the electromagnetic rebound operating unit 41 (Hereinafter, this direction will be referred to as a circuit-opening direction in the vacuum contact point unit 7 and the opposite direction will be referred to as a circuit-closing direction).

The movable shaft 43 moves in the circuit-opening direction. The brim 46 compresses the wiping spring 48. The movable shaft 43 collides with the shock absorber 50. At this time, the movable shaft 43 is restrained from rebounding in the circuit-closing direction by the shock absorber 50. The movable shaft 43 pushes the coupling 47 in the circuit-opening direction through the wiping spring 48 and the shock absorber 50.

Meanwhile, before the timing at which the coupling 47 is pushed in the circuit-opening direction by the movable shaft 43, a current is supplied from an external power supply to the electromagnetic solenoid 53 of the holding mechanism unit 203. Thus, the electromagnetic solenoid 53 is excited in such a direction as to cancel the magnetic flux of the permanent magnet 51. The attracting force of the permanent magnet 51 acting on the movable member 54 is reduced and the movable member 54 is driven in the circuit-opening direction by the biasing force of the circuit-opening spring 52.

The brim presser 49 comes into contact with the brim 46 through the coupling 47. Thus, the movable member 54 pulls the coupling 47, the brim presser 49 and the brim 46 together. The movable member 54 further opens the movable electrode 14 through the movable shaft 43. Thereafter, the movable electrode 14 is opened by the inertial force of the movable shaft 43 and the biasing force of the circuit-opening spring 52 until a predetermined gap is formed. The movable member 54 collides with the shock absorber 55. The shock is absorbed by the shock absorber 55 and the movable member 54 is stopped. The predetermined gap refers to a spacing between the contact point of the fixed electrode 11 and the contact point of the movable electrode 14 which is required in the current interruption.

After the spacing between the movable electrode 14 and the fixed electrode 11 becomes the predetermined gap, the supply of the current to the electromagnetic rebound coil 44 and the electromagnetic solenoid 53 is stopped to cancel the excitation of the electromagnetic rebound coil 44 and the electromagnetic solenoid 53. For example, a capacitor having accumulated charges may be used as the external power supply. The accumulated charges may be discharged. The excitation may be cancelled by allowing the charges to become zero. After the excitation is cancelled, the contact point of the vacuum valve 8 is kept in an open-circuit state. This is because the biasing force of the circuit-opening spring 52 is larger than the sum of the self-closing force of the vacuum valve 8 and the attracting force of the permanent magnet 51.

### (Feed State)

In the feed state shown in FIG. 3, the fixed electrode 11 and the movable electrode 14 of the vacuum valve 8 make contact with each other at a predetermined load. The attracting force applied to the movable member 54 by the permanent magnet 51 is set larger than the circuit-opening force applied by the wiping spring 48 and the circuit-opening spring 52. For that reason, by virtue of the attracting force of the permanent magnet 51, the two hands 54b of the movable member 54 compresses the circuit-opening spring 52 and makes contact with the permanent magnet 51. The movable member 54 is fixed to the permanent magnet 51. Meanwhile, by virtue of the attracting force, the movable electrode 14 makes contact with the fixed electrode 11 through the movable shaft 43. The biasing force of the wiping spring 48 is applied to the movable electrode 14. In this way, the movable electrode 14 and the fixed electrode 11 of the vacuum valve 8 make contact with each other at the load applied by the wiping spring 48. The feed state (closed-circuit state) is maintained by the attracting force of the permanent magnet 51 applied to the movable member 54.

### (Effects)

The switchgear of the present embodiment provides the following effects in addition to the effects provided by the switchgear of the first embodiment. In the present embodiment, the electromagnetic rebound operating unit 41 is used as an operating unit. The vacuum contact point unit 7 is short in the stroke which is the moving distance of the contact point of the movable electrode 14 required in the current interruption. The weight of the movable members is small. Therefore, high responsiveness is obtained in the opening operation. This makes it possible to further shorten the interruption time.

Particularly, in the present embodiment, the high-speed opening unit 201 which includes the electromagnetic rebound coil 44, the support portion 57 for fixing the electromagnetic rebound coil 44 and the rebound ring 45 installed to face the electromagnetic rebound coil 44 is installed in the electromagnetic rebound operating unit 41. For that reason, due to the electromagnetic rebound force acting between the excited electromagnetic rebound coil 44 and the rebound ring 45, the rise of the driving force is quite faster in the electromagnetic rebound operating unit 41 for performing the opening operation than in the operating unit which uses a spring force or a hydraulic pressure as a driving source. It is therefore possible to obtain extremely high responsiveness. For that reason, the SLF interruption performance for a steep transient recovery voltage is superior.

A thrust force generation means for applying a thrust force to the contact point of the vacuum valve 8 is installed in the electromagnetic rebound operating unit 41. More specifically, there are installed the movable member 54 indirectly connected to the movable shaft 43 through the coupling 47, the brim presser 49 and the brim 46 etc. and made of a good conductor, the permanent magnet 51, and the electromagnetic solenoid 53. Thus, the attracting force of the permanent magnet 51 and the attracting force of the excited electromagnetic solenoid 53 act on the movable member 54. Consequently, a thrust force acting in the circuit-closing direction is generated in the movable member 54 and the movable shaft 43. This makes it possible to drive the movable electrodes 14 and 18 into contact with the fixed electrodes 11 and 12.

### OTHER EMBODIMENTS

While a plurality of embodiments of the present disclosure has been described in the subject specification, these embodiments are presented by way of example and are not intended to limit the scope of the present disclosure. More specifically, the combination of the whole or any one of the first and second embodiments is included in the scope of the present disclosure. The embodiments described above can be carried out in many other forms. Different omissions, substitutions and modifications can be made without departing from the scope of the disclosures. These embodiments and the modifications thereof are included in the scope and spirit of the disclosures and are also included in the scope equivalent to the disclosures recited in the claims.

(1) In the second embodiment, the movable member 54 of the holding mechanism unit 203 is indirectly connected to the movable shaft 43 of the high-speed opening unit 201 through the wiping mechanism unit 202. However, the movable member 54 may be directly connected to the movable shaft 43.

(2) Other operating units may be used as the operating unit. As an example, a linear motor may be installed in an operating unit existing outside the container. It may be possible to use a linear operating unit that performs opening/closing operations using the magnetic interaction of the linear motor.

The linear operating unit exhibits a property lying between the operating unit which uses a spring force or a hydraulic pressure as a driving source and the electromagnetic rebound operating unit 41 of the second embodiment which uses an electromagnetic rebound force as a driving source. That is to say, in the linear operating unit, the rise of the driving force is a little slower than that of the electromagnetic rebound operating unit 41 but is sufficiently faster than that of the operating unit which uses a spring force or a hydraulic pressure as a driving source.

It may be possible to use an outer permanent magnet 67 and an inner permanent magnet 68 which are larger in magnetization energy than the electromagnetic rebound operating unit 41. The number of the outer permanent magnet 67 and the inner permanent magnet 68 may be increased. The winding number of a three-phase coil 66a may be increased. This makes it easy to increase the driving energy.

Accordingly, the linear operating unit of the present embodiment is an operating unit which is suitable in case where a contact point unit requires a relatively long stroke and high responsiveness. Since the gas contact point unit 9 requires this performance, by applying the linear operating unit of the present embodiment to the gas contact point unit 9, high responsiveness is obtained in the opening operation. It is possible to provide a switchgear capable of further shortening the interruption time.

(3) A capacitor may be installed in parallel with respect to the vacuum valve 8. By connecting the capacitor in parallel with respect to the vacuum valve 8, the voltage applied to the vacuum valve 8 can be made lower than the voltage applied to the contact point of the gas contact point unit 9. This makes it possible to enhance the voltage resistance performance of the switchgear.

At this time, the capacitance of the capacitor is decided in view of the parasitic capacitance of the contact point of the gas contact point unit 9 and the vacuum valve 8 and in view of the voltage resistance value of the contact point and the vacuum valve 8. That is to say, the capacitance c of the capacitor 71 is set to satisfy a relationship of c=(B/A)b−a where A is the voltage resistance value of the vacuum valve 8, B is the voltage resistance value of the contact point of the gas contact point unit 9, a is the parasitic capacitance of the vacuum valve 8, b is the parasitic capacitance of the contact point of the gas contact point unit 9, and c is the capacitance of the capacitor 71. By designing the capacitance of the capacitor as above, the ratio of the voltage resistance values of the vacuum valve 8 and the contact point of the gas contact point unit 9 can be made equal to the ratio of the partial pressures of the vacuum valve 8 and the contact point of the gas contact point unit 9. The voltage resistance value V of the switchgear can be increased to V=A+B.

(4) A surge absorber may be installed in parallel with respect to the vacuum valve 8. By electrically connecting the surge absorber in parallel with the vacuum valve 8, the surge absorber comes into an energized state prior to the breakdown of the vacuum valve 8 in case where the transient recovery voltage applied after fault current interruption exceeds the clamping voltage of the surge absorber. A voltage exceeding the clamping voltage of the surge absorber is not applied to the vacuum valve 8.

As a result, the majority of the voltage applied to the switchgear is shared by the contact point 10 of the gas contact point unit 9 which is high in dielectric strength. This makes it possible to improve the voltage resistance performance of the switchgear.

What is claimed is:

1. A switchgear comprising:
a sealed container filled with an insulating medium
an insulation spacer configured to divide the inside of the sealed container into a first space and a second space;
a first contact unit located in the first space comprising a first movable electrode operable to be connected or disconnected to a first fixed electrode at a first contact point;
a second contact unit located in the second space comprising a second movable electrode operable to be connected or disconnected to a second fixed electrode at a second contact point;
an electrode extending through the insulation spacer and fixed to the insulation spacer;
an operating rod connected to an operating unit and the first movable electrode, the operating unit configured to drive the operating rod in a first direction; and
a first connecting member located within the sealed container configured to link the operating rod with the second movable electrode;
wherein when the operating unit drives the operating rod in a first direction, the first movable electrode is disconnected from the first fixed electrode in the first direction and the second movable electrode is disconnected from the second fixed electrode in a second direction by the first connecting member, the second direction being opposite the first direction.

2. The switchgear of claim 1 further comprising:
a second connecting member located within the sealed container configure to link the operating rod with the second movable electrode;
wherein when the operating unit drives the operating rod in a first direction, the first movable electrode is disconnected from the first fixed electrode in the first direction and the second movable electrode is disconnected from the second fixed electrode in a second direction by the first connecting member and the second connecting member, the second direction being opposite the first direction.

3. The switchgear of claim 2 wherein the first connecting member and the second connecting member are located in both the first space and second space, through the insulation spacer.

4. The switchgear of claim 3, wherein a seal rod is disposed in a portion of an insulation operating rod slidably supported on the insulation spacer, and
the internal spaces are kept air-tight by the portion slidably supporting the seal rod and by the seal rod.

5. The switchgear of claim 1, wherein at least one of the contact point units includes a connecting unit configured to transmit a driving force of the operating unit to the contact point,
the operating unit is disposed outside the sealed container, and
the connecting unit is configured to extend through the sealed container while maintaining the air-tightness of the inside of the sealed container, and the connecting unit is connected to the operating unit.

6. The switchgear of claim 1, wherein at least one of the contact point units is a vacuum contact point unit including a vacuum valve provided with a contact point, and
at least one of the contact point units is a contact point unit including a contact point larger in dielectric strength than the contact point of the vacuum valve.

7. The switchgear of claim 1, wherein the operating unit for operating the contact point units includes:
a coil;
a coil fixing portion configured to fix the coil;
an opposite good conductor installed so as to face the coil;
a movable shaft extending through the opposite good conductor and fixed to the opposite good conductor; and
a coil excitation means configured to supply a current to the coil and configured to excite the coil, and
wherein the coil is excited to generate a rebound force between the coil and the opposite good conductor, thereby applying a thrust force to the movable shaft.

8. The switchgear of claim 7, further comprising a closing means attached to the movable shaft and configured to generate a thrust force acting in a direction in which the movable electrode of the contact point unit is brought into contact with the fixed electrode.

9. The switchgear of claim 8, wherein the closing means includes an electromagnetic solenoid and a permanent magnet.

10. The switchgear of claim 1, wherein the insulating medium is an SF₆ gas.

11. A switchgear comprising:
a sealed container filled with an insulating medium;
an insulation spacer configured to divide the inside of the sealed container into two internal spaces; and
an electrode extending through the insulation spacer and fixed to the insulation spacer,
wherein contact point units are installed in the respective internal spaces, each of the contact point units including a contact point formed of a fixed electrode and a movable electrode capable of making contact with or moving away from the fixed electrode,
the direction in which one of the movable electrode is moved away from the fixed electrode is opposite to the direction in which the other movable electrode is moved away from the fixed electrode,
the switchgear further comprises a connecting member disposed within the sealed container, the connecting member configured to move the other movable electrode in the opposite direction to the moving direction of one of the movable electrodes, and
the respective movable electrodes are driven in conjunction with each other by an operating unit for driving one of the movable electrodes.

12. The switchgear of claim 11, wherein the connecting member includes:
a connecting rod configured to move within the internal space in conjunction with one of the movable electrodes;
a link mechanism configured to move in the opposite direction to the moving direction of the connecting rod; and
an insulation operating rod extending through the insulation spacer, the insulation operating rod configured to link the movement of the link mechanism to the movement of the movable electrode of the other internal space.

13. The switchgear of claim 12, wherein a seal rod is disposed in the portion of the insulation operating rod slidably supported on the insulation spacer, and
the internal spaces are kept air-tight by the portion slidably supporting the seal rod and by the seal rod.

14. The switchgear of claim 11, wherein at least one of the contact point units includes a connecting unit configured to transmit a driving force of the operating unit to the contact point,
the operating unit is disposed outside the sealed container, and
the connecting unit is configured to extend through the sealed container while maintaining the air-tightness of the inside of the sealed container, and the connecting unit is connected to the operating unit.

15. The switchgear of claim 11, wherein at least one of the contact point units is a vacuum contact point unit including a vacuum valve provided with a contact point, and
at least one of the contact point units is a contact point unit including a contact point larger in dielectric strength than the contact point of the vacuum valve.

16. The switchgear of claim 11, wherein the operating unit for operating the contact point units includes:
a coil;
a coil fixing portion configured to fix the coil;
an opposite good conductor installed so as to face the coil;
a movable shaft extending through the opposite good conductor and fixed to the opposite good conductor; and
a coil excitation means configured to supply a current to the coil and configured to excite the coil, and
wherein the coil is excited to generate a rebound force between the coil and the opposite good conductor, thereby applying a thrust force to the movable shaft.

17. The switchgear of claim 16, further comprising a closing means attached to the movable shaft and configured to generate a thrust force acting in a direction in which the movable electrode of the contact point unit is brought into contact with the fixed electrode.

18. The switchgear of claim 17, wherein the closing means includes an electromagnetic solenoid and a permanent magnet.

19. The switchgear of claim 11, wherein the insulating medium is an SF₆ gas.
